(19) United States
(12) Patent Application Publication
(10) Pub. No.: US 2013/0300757 A1
(43) Pub. Date: Nov. 14, 2013

(54) Volumetric Display

(71) Applicant: Jyrki Kimmel, Tampere (FI)

(72) Inventor: Jyrki Kimmel, Tampere (FI)

(73) Assignee: Nokia Corporation, Espoo (FI)

(21) Appl. No.: 13/882,527

(22) PCT Filed: Nov. 2, 2010
(86) PCT No.: PCT/IB10/54944

§ 371 Date: Jul. 19, 2013

(51) Int. Cl. G02B 27/22

(52) U.S. Cl. CPC G02B 27/2292
USPC 345/564

(57) ABSTRACT

A method including storing a data structure that defines at least part of a surface within a volume, including a non-overlapping set of sub-volumes, by specifying, for different first positions of a first straight line, a distance along the first straight line of a sub-volume of a sub-set of sub-volumes that defines the at least part of the surface; and using the data structure to control a first scanner, configured to address sub-volumes that lie along a first straight line at different positions of the first straight line, and to control a second scanner, configured to address sub-volumes that lie along a second straight line for different positions of the second straight line, to address co-operatively the sub-set of sub-volumes that defines the at least part of the surface.

### TECHNOLOGICAL FIELD

Embodiments of the present invention relate to volumetric display. In particular, some embodiments relate to scanned-volume volumetric display.

### BACKGROUND

A volumetric display apparatus is a graphical display apparatus that forms a visual representation of an object in three physical dimensions.

Typically a volumetric display is autostereoscopic and renders three-dimensional images to an unaided human eye.

A scanned-volume volumetric display apparatus relies on the persistence of human vision for a series of activated sub-volumes to be rendered as a single three-dimensional image.

If the three-dimensional image is to have a reasonable resolution, then the volume in which the three-dimensional image is rendered must be divided into a large number of sub-volumes. A data structure may be used to indicate, for each sub-volume, an activation state. The data structure may be extremely large which is problematic. It may be made smaller by reducing the resolution but this is undesirable.

### BRIEF SUMMARY

According to various, but not necessarily all, embodiments of the invention there is provided a method comprising: storing a data structure that defines at least part of a surface within a volume, comprised of a non-overlapping set of sub-volumes, by specifying, for different first positions of a first straight line, a distance along the first straight line of a sub-volume of a sub-set of sub-volumes that defines the at least part of the surface; and using the data structure to control a first scanner, configured to address sub-volumes that lie along a first straight line at different positions of the first straight line, and to control a second scanner, configured to address sub-volumes that lie along a second straight line for different positions of the second straight line, to address co-operatively the sub-set of sub-volumes that defines the at least part of the surface.

According to various, but not necessarily all, embodiments of the invention there is provided an apparatus comprising: a memory configured to store a data structure that defines at least part of a surface within a volume, comprised of a non-overlapping set of sub-volumes, by specifying, for different first positions of a first straight line, a distance along the first straight line of a sub-volume of a sub-set of sub-volumes that defines the at least part of the surface; and a controller configured to access the data structure stored in the memory and configured to use the data structure to control a first scanner, configured to address sub-volumes that lie along a first straight line at different positions of the first straight line, and to control a second scanner, configured to address sub-volumes that lie along a second straight line for different positions of the second straight line, to address co-operatively the sub-set of sub-volumes that defines the at least part of the surface.

According to various, but not necessarily all, embodiments of the invention there is provided a controller comprising: an interface configured to access a data structure that defines at least part of a surface within a volume, comprised of a non-overlapping set of sub volumes, by specifying, for different first positions of a first straight line, a distance along the first straight line of a sub-volume of a sub-set of sub-volumes that defines the at least part of the surface; and circuitry configured to use the data structure to control a first scanner, configured to address sub-volumes that lie along a first straight line at different positions of the first straight line, and to control a second scanner, configured to address sub-volumes that lie along a second straight line for different positions of the second straight line, to address co-operatively the sub-set of sub-volumes that defines the at least part of the surface.

According to various, but not necessarily all, embodiments of the invention there is provided an apparatus comprising: at least one processor; and at least one memory including computer program code the at least one memory and the computer program code configured to, with the at least one processor, cause the apparatus at least to perform accessing a data structure that defines at least part of a surface within a volume, comprised of a non-overlapping set of sub-volumes, by specifying, for different first positions of a first straight line, a distance along the first straight line of a sub-volume of a sub-set of sub-volumes that defines the at least part of the surface; and using the data structure to control a first scanner, configured to address sub-volumes that lie along a first straight line at different positions of the first straight line, and to control a second scanner, configured to address sub-volumes that lie along a second straight line for different positions of the second straight line, to address co-operatively the sub-set of sub-volumes that defines the at least part of the surface.

According to various, but not necessarily all, embodiments of the invention there is provided a volumetric imaging application specific processor configured to convert a series of distance values, for distances along a first straight line at a series of different first positions, to a series of second positions of a second straight line that serially intersects the first straight line at the series of different first positions.

### BRIEF DESCRIPTION

For a better understanding of various examples of embodiments of the present invention reference will now be made by way of example only to the accompanying drawings in which:

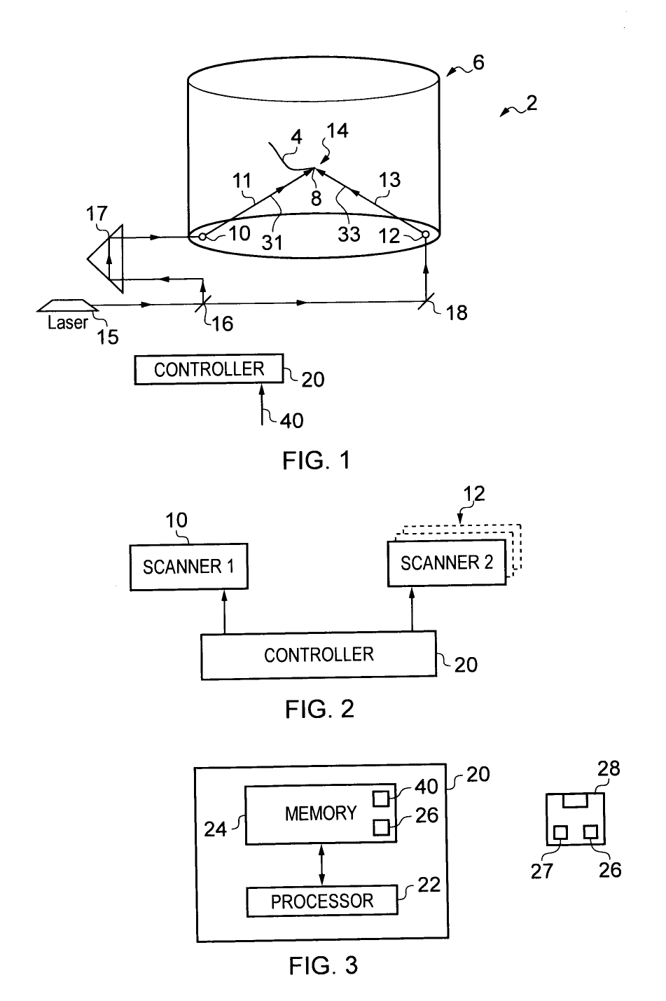

FIG. 1 schematically illustrates a volumetric display apparatus that uses a reduced data structure to control a first scanner and at least a second scanner;

FIG. 2 schematically illustrates an example of a controller configured to control the first scanner and to control one or more second scanners;

FIG. 3 schematically illustrates another example of the controller;

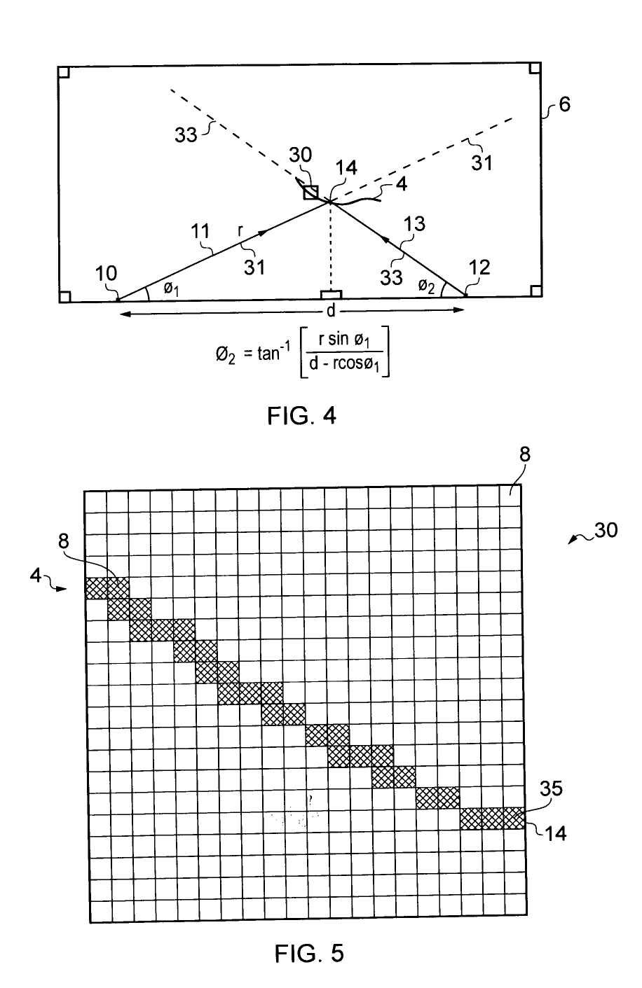

FIG. 4 gives a two-dimensional example of how to convert a distance value along a first straight line at a first position to a second positions of a second straight line 33 that intersects the first straight line at the distance value;

FIG. 5 schematically illustrates, in two dimensions, the rendered surface in close up;

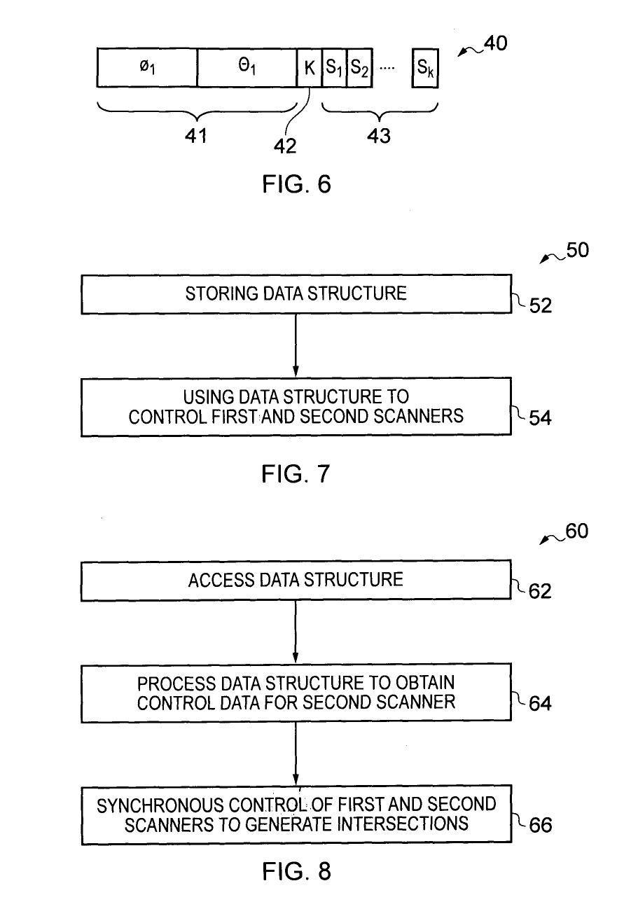

FIG. 6 is a schematic illustration of a data structure that is configured to enable the definition of multiple discrete surfaces;

FIG. 7 schematically illustrates a method; and

FIG. 8 schematically illustrates a method for controlling output from the volumetric display apparatus.

### DETAILED DESCRIPTION

FIG. 1 schematically illustrates a volumetric display apparatus 2 that uses a reduced data structure to control a first scanner 10 and a second scanner 12 to address co-operatively a sub-set of sub-volumes 8 that defines at least part of a surface 4 within a volume 6. The volumetric display apparatus 2 produces as its output a visual representation of the at least part of the surface 4.

The first scanner 10 is configured to address sub-volumes 8 that lie along a first straight line 31 at different positions of the first straight line 31.

The second scanner 12 is configured to address sub-volumes 8 that lie along a second straight line 33 at different positions of the second straight line 33.

A sub-volume 8 is addressed co-operatively at an intersection of the first straight line 31 originating from the first scanner 10 and the second straight line 33 originating from the second scanner 12, when the first scanner and the second scanner simultaneously address the same sub-volume 8.

Addressing co-operatively the sub-set of sub-volumes 8 produces a visible light output from the sub-set of sub-volumes 8 that defines the surface 4.

The first scanner 10 and second scanner 12 co-operatively address only sub-volumes specified by a data structure 40 which are only a small fraction of the sub-volumes within the volume 6. The volume 6 is comprised of a non-overlapping set of N sub-volumes. The data structure 40 defines a surface 4 within the volume 6 by specifying, for different first positions of the first straight line 31, a distance along the first straight line 31 of a sub-volume 8 of a sub-set of sub-volumes 8 that defines the surface 4. In this way, the data structure specifies M sub-volumes where M<<N. The data structure 40 does not specify the N-M sub-volumes that are within the volume 6 but are not part of the surface (or surfaces) 4 defined by the data structure 40.

The particular example of an apparatus 2 schematically illustrated in FIG. 1, is volumetric display apparatus 2 that creates a visual output by intersecting light beams sequentially in different sub-volumes 8 of a scattering volume 6.

The apparatus 2 comprises a light source 15 which may, for example, be a laser. The light beam from the laser is split by a beam splitter 16 into a first light beam 11 that travels through an optical path length compensator 17 to a first scanner 10 and a second light beam 12 that is reflected off a mirror to a second scanner 18. The optical path length compensator 17 is, in this example, a prism that makes the optical path length from the beam splitter 16 to the first scanner 10 the same as the optical path length from the beam splitter 16 to the second scanner 12.

The first scanner 10 may be an optical scanner such as, for example a movable mirror. The movable mirror may, for example, be a micro-electro-mechanical (MEM) element. The first optical scanner 10 directs the first light beam 11 along the first direction 31. The first light beam 11 is scanned by moving the mirror to change the first direction 31. In this way, the first scanner 10 is configured to address sub-volumes 8 that lie along a first straight line 31 at different positions of the first straight line 31.

The second scanner 12 may be an optical scanner such as, for example a movable mirror. The movable mirror may, for example, be a micro-electro-mechanical (MEM) element. The second optical scanner 12 directs the second light beam 12 along the second direction 33. The second light beam 13 is scanned by moving the mirror to change the second direction 33. In this way, the second scanner 12 is configured to address sub-volumes 8 that lie along a second straight line 33 at different positions of the second straight line 33.

A controller 20 controls the first optical scanner 10 and the second optical scanner 12 so that they simultaneously co-operate to cross the first light beam 10 and the second light beam 13 at a desired sub-volume 8.

The controller 20 is configured to control the first optical scanner 10 to move the first straight line 31 (along which the first light beam 11 travels) between a multiplicity of first positions.

The controller 20 is configured to control the second optical scanner 12 to move the second straight line 33 (along which the second light beam 13 travels) between a multiplicity of second positions.

The controller 20 is configured to co-ordinate the movement of the first straight line 31 (along which the first light beam travels) and the second straight line 33 (along which the first light beam travels) to address co-operatively the sub-set of sub-volumes 8 at the intersection 14 of the first light beam 11 and the second light beam 13.

Addressing co-operatively the sub-set of sub-volumes 8 produces a visible light output from the sub-set of sub-volumes 8 that defines the at least part of the surface 4.

FIG. 8 schematically illustrates a method 60 for controlling output from the volumetric display apparatus 2.

At block 62, a controller 20 accesses the data structure 40. The data structure 40 defines at least part of a surface 4 within the volume 6 by specifying, for different first positions of a first straight line 31, a distance along the first straight line 31 of a sub-volume 8 of a sub-set of sub-volumes 8 that defines the at least part of the surface 4.

Next, at block 64, the controller processes the data structure 40 to obtain control data for the second scanner 12. The controller 20 may be configured to convert a series of distance values for distances along the first straight line 31 at a series of different first positions, to a series of second positions of the second straight line 33 that cause the second straight line 33 to serially intersect the first straight line 31 at each of the distances along the first straight line 31 at the series of different first positions.

Next at block 66, the controller 20 co-ordinates the movement of the first straight line 31 (along which the first light beam travels) and the second straight line 33 (along which the second light beam travels) to address co-operatively the sub-set of sub-volumes 8 at the intersection 14 of the first light beam 11 and the second light beam 13. A series of intersections 14 are generated which create a visual representation of the surface 4.

FIG. 2 schematically illustrates an example of the controller 20. The controller 20 is configured to control the first scanner 10 and to control one or more second scanners 12. The controller 20 is configured to co-ordinate the movement of the first straight line 31(along which the first light beam travels) originating from the first scanner 10 and the second straight line(s) 33 (along which the second light beam(s) travels) originating from the second scanners 12 to address co-operatively the sub-set of sub-volumes 8 at the intersection 14 of the first light beam 11 and the second light beam(s) 13.

The controller 20 enables simultaneous addressing of the sub-volume where the second straight line 33 at the second position and the first straight line 31 at the first position intersect.

The position of the sub-volume 8 that is to be addressed from an origin at the first scanner 10 is the vector r₁. The different positions of the first straight line 31 are different orientations from a first origin.

The position of the sub-volume 8 that is to be addressed from a second origin at the second scanner 12 is the vector r₂. The different positions of the second straight line 33 are different orientations from the second origin

The fixed displacement of the second scanner 12 from the first scanner is the vector d.

The vector r₁ is typically defined in the data structure 40 in a reduced format and the vector d is known. The controller 20 is therefore able to access the data structure 40, for example, via an internal or external interface and determine r₂.

For example, the vector r₁ may be expressed in spherical coordinates as (r₁, φ₁, θ₁). The position of the first straight line 31 is given by the couplet (φ₁, θ₁). The distance along the first straight line 31 is given by r₁.

The data structure 40 may, for example, comprise an entry that has a field for r₁, a field for φ₁ and a field for θ₁.

Alternatively the data structure 40 may, for example, have a predetermined ordered arrangement of entries one for each possible position of the first straight line 31 i.e. one for every couplet (φ₁, θ₁). An entry may be blank or null if the data structure does not specify, for a particular position of the first straight line 31, a distance along that first straight line 31. An entry will have a data value r₁ whenever the data structure specifies, for that particular position of the first straight line 31, a distance along that first straight line 31.

The stored data structure may define at least one whole surface 4 within the volume 6 by specifying, for a sub-set of the possible different first positions of a first straight line 31, a distance along the first straight line 31 of a sub-volume 8.

The controller 20 may be configured to convert a series of distance values {r} for distances along the first straight line 31 at a series of different first positions (φ₁, θ₁), to a series of second positions (φ₂, θ₂) of the second straight line 33 that cause the second straight line 33 to serially intersect the first straight line 31 at each of the distances {r} along the first straight line 31 at the series of different first positions (φ₁, θ₁).

The distinction between the first straight line 31 and the second straight line 33 is arbitrary. For example, the controller 20 may instead be configured to convert a series of distance values {r} for distances along the second straight line 33 at a series of different second positions (^{SM}₂, θ₂), to a series of first positions (φ₁, θ₁) of the first straight line 31 that cause the first straight line 31 to serially intersect the second straight line 33 at each of the distances {r} along the second straight line 33 at the series of different second positions (φ₂, θ₂).

FIG. 4 gives a two-dimensional example of how to convert a distance value {r} along the first straight line 31 at a first position (φ₁) to a second positions (φ₂) of the second straight line 33 that causes the second straight line 33 to intersect the first straight line 31 at the distance r along the first straight line 31 when the first straight line 31 is at the first positions φ₁.

φ₂=tan⁻¹[r.sin φ₁/(d−4.cos φ₁)]

The example can be simply extended to three dimensions.

φ₂=tan⁻¹[r.cos θ₁.sin φ₁/(d−r. .cos θ_{1.}cos φ₁)]

θ₂=tan⁻¹[r.sin θ₁.cos φ₂/(d−r. .cos θ₁.cos ^{SM}₂) ]

Implementation of the controller can be in hardware alone (a circuit, a processor . . . ), have certain aspects in software including firmware alone or can be a combination of hardware and software (including firmware).

The controller may be implemented using instructions that enable hardware functionality, for example, by using executable computer program instructions in a general-purpose or special-purpose processor that may be stored on a computer readable storage medium (disk, memory etc) to be executed by such a processor.

The controller 40 may, for example, be a volumetric imaging application specific processor that has a dedicated purpose or it may be provided using a programmable processor as illustrated in FIG. 3.

FIG. 3 schematically illustrates another example of the controller 20. The controller 20 comprises: at least one processor 22; and at least one memory 24 including computer program code 26 the at least one memory 24 and the computer program code 26 configured to, with the at least one processor 22, cause the controller 20 at least to perform accessing a data structure 40 that defines at least part of the surface 4 within the volume 6 by specifying, for different first positions of the first straight line 31, a distance along the first straight line 31 of a sub-volume 8 of a sub-set of sub-volumes 8 that defines the at least part of the surface 4; and using the data structure 40 to control a first scanner 10, configured to address sub-volumes 8 that lie along the first straight line 31 at different positions of the first straight line 31, and to control the second scanner 12, configured to address sub-volumes 8 that lie along the second straight line 33 for different positions of the second straight line 33, to address co-operatively the sub-set of sub-volumes 8 that defines the at least part of the surface 4.

The data structure 40 may be stored in the memory 24 or a different memory inside or outside the controller 20.

The at least one memory 24 and the computer program code 26 are, in this example, configured to, with the at least one processor 22, cause the processor 22 to convert a distance r along a first straight line 31 at a first position to a second position of a second straight line 33 that intersects the first straight line at the first position at the distance r along the first straight line 31.

The processor 22 is configured to read from and write to the memory 24. The processor 22 may also comprise an output interface via which data and/or commands are output by the processor and an input interface via which data and/or commands are input to the processor 22.

The memory 24 stores a computer program 26 comprising computer program instructions that control the operation of the apparatus 2 when loaded into the processor 22. The computer program instructions 26 provide the logic and routines that enables the apparatus to perform the methods illustrated in FIGS. 7 and 8. The processor 22 by reading the memory 24 is able to load and execute the computer program 26.

The computer program may arrive at the apparatus 2 via any suitable delivery mechanism 28. The delivery mechanism 28 may be, for example, a computer-readable storage medium, a computer program product, a memory device, a record medium such as, for example, a compact disc read-only memory (CD-ROM) or digital versatile disc (DVD), an article of manufacture that tangibly embodies the computer program 26. The delivery mechanism may be a signal configured to reliably transfer the computer program 26. The apparatus 2 may propagate or transmit the computer program 26 as a computer data signal.

Although the memory 24 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a)hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.”

FIG. 5 schematically illustrates, in two dimensions, the rendered surface 4 in close up. This close-up magnified view schematically illustrates the sub-volumes 8 that form a part 30 of the volume 6. The sub-set of sub-volumes 8 that defines the surface 4 are shaded in the Figure.

FIG. 6 is a schematic illustration of a data structure 40 that is configured to enable the definition of multiple discrete surfaces 4.

For example, the location of each sub-volume 8 of a first surface can be located using the triplet (s₁, φ₁, θ₁) where the position of the first straight line 31 is given by the couplet (φ₁, θ₁) and the distance along the first straight line 31 to the first surface is given by s₁. The location any sub-volume 8 of a second surface can be located using the triplet (s₂, φ₁, θ₁) where the position of the first straight line 31 is given by the couplet (φ₁, θ₁) and the distance along the first straight line 31 to the second surface is given by s₂.

Rather than having double entries (s₁, φ₁, θ₁) (s₂, φ₁, θ₁) the data structure may instead have a single entry (φ₁, θ₁, s₁, s₂), The position of the first straight line 31 is given by the couplet (φ₁, θ₁). The distance along the first straight line 31 to the first surface is given by s₁. The distance along the first straight line 31 to the second surface is given by s₂.

This data structure 40 defines at least part of a second surface within the volume by specifying, for different positions of the first straight line 31, a distance along the first straight line 31 of a sub-volume 8 of a second sub-set of sub-volumes 8 that defines the at least part of the second surface. This data structure 40 is used to control the first scanner 10 and to control the second scanner 12 to address co-operatively the second sub-set of sub-volumes 8 that defines the at least part of the second surface.

The data structure 40 specifies, for different first positions of a first straight line 31, one or more distances along the first straight line 31 that define the locations of one or more sub-volumes 8 that define one or more surfaces.

FIG. 7 schematically illustrates a method 50.

The method starts at block 52. A data structure 40 is stored. The stored data structure 40 defines at least part of a surface 4 within the volume 6 by specifying, for different first positions of a first straight line 31, a distance along the first straight line 31 of a sub-volume 8 of a sub-set of sub-volumes 8 that defines the at least part of the surface 4.

Next at block 54, the data structure 40 is used to control the first scanner 10 and the second scanner to address co-operatively the sub-set of sub-volumes 8 that defines the at least part of the surface 4. The first scanner 10 is configured to address sub-volumes 8 that lie along the first straight line 31 at different positions of the first straight line 31. The second scanner is configured to address sub-volumes 8 that lie along a second straight line 33 for different positions of the second straight line 33.

As used here ‘module’ refers to a unit or apparatus that excludes certain parts/components that would be added by an end manufacturer or a user. The controller 20 may be a module.

The blocks illustrated in the FIGS. 7 and 8 may represent steps in a method and/or sections of code in the computer program 26. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
storing a data structure that defines at least part of a surface within a volume, comprised of a non-overlapping set of sub-volumes, by specifying, for different first positions of a first straight line, a distance along the first straight line of a sub-volume of a sub-set of sub-volumes that defines the at least part of the surface; and
using the data structure to control a first scanner, configured to address sub-volumes that lie along a first straight line at different positions of the first straight line, and to control a second scanner, configured to address sub-volumes that lie along a second straight line for different positions of the second straight line, to address co-operatively the sub-set of sub-volumes that defines the at least part of the surface.

2. A method as claimed in claim 1, wherein addressing co-operatively the subset of sub-volumes produces a visible light output from the sub-set of sub-volumes that defines the at least part of the surface.

3. A method as claimed in claim 1, wherein a sub-volume is addressed co-operatively at an intersection of the first straight line and second straight line.

4. A method as claimed in claim 1, wherein a sub-volume is addressed co-operatively when the first scanner and the second scanner simultaneously address the same sub-volume.

5. A method as claimed in claim 1, wherein the first scanner and second scanner co-operatively produce outputs for addressing only sub-volumes specified by the data structure and none of the other plurality of sub-volumes comprised in the volume.

6. A method as claimed in claim 1, wherein the data structure defines at least part of a second surface within the volume by specifying, for different positions of the first straight line, a distance along the first straight line of a sub-volume of a second sub-set of sub-volumes that defines the at least part of the second surface; and using the data structure to control the first scanner and to control the second scanner to address co-operatively the second sub-set of sub-volumes that defines the at least part of the second surface.

7. A method as claimed in claim 1, wherein the data structure specifies, for different first positions of a first straight line, one or more distances along the first straight line that define the locations of one or more sub-volumes that define one or more surfaces.

8. A method as claimed in claim 1, further comprising: converting the distance along the first straight line at a first position to a second position of the second straight line.

9. A method as claimed in claim 8, comprising using an application specific processor to convert the distance along the first straight line at a first position to a second position of the second straight line.

10. A method as claimed in claim 8, further comprising:
simultaneously addressing the sub-volume where the second straight line at the second position and the first straight line at the first position intersect.

11. A method as claimed in claim 1, further comprising:
moving the first straight line between a multiplicity of first positions;
moving the second straight line between a multiplicity of second positions;
co-coordinating the movement of the first straight line and the second straight line to address co-operatively the sub-set of sub-volumes at the intersection of the first straight line and the second straight line.

12. A method as claimed in claim 11, comprising moving the second straight line faster than the first straight line.

13. A method as claimed in claim 1, wherein the different positions of the first straight line are different orientations from a first origin, wherein the different positions of the second straight line are different orientations from a second origin and wherein the first origin and second origin have a fixed spatial relationship.

14. A method as claimed in claim 1, wherein the data structure specifies distances along the first straight line for different first positions of a first straight line using a spherical co-ordinate system.

15. A method as claimed in claim 1, wherein the stored data structure defines at least one whole surface within the volume by specifying, for a sub-set of the possible different first positions of a first straight line, a distance along the first straight line of a sub-volume.

16. An apparatus comprising: means for performing the method of claim 1.

17. An apparatus comprising:
a memory configured to store a data structure that defines at least part of a surface within a volume, comprised of a non-overlapping set of sub-volumes, by specifying, for different first positions of a first straight line, a distance along the first straight line of a sub-volume of a sub-set of sub-volumes that defines the at least part of the surface; and
a controller configured to access the data structure stored in the memory and configured to use the data structure to control a first scanner, configured to address sub-volumes that lie along a first straight line at different positions of the first straight line, and to control a second scanner, configured to address sub-volumes that lie along a second straight line for different positions of the second straight line, to address co-operatively the sub-set of sub-volumes that defines the at least part of the surface.

18. A controller comprising:
an interface configured to access a data structure that defines at least part of a surface within a volume, comprised of a non-overlapping set of sub-volumes, by specifying, for different first positions of a first straight line, a distance along the first straight line of a sub-volume of a sub-set of sub-volumes that defines the at least part of the surface; and
circuitry configured to use the data structure to control a first scanner, configured to address sub-volumes that lie along a first straight line at different positions of the first straight line, and to control a second scanner, configured to address sub-volumes that lie along a second straight line for different positions of the second straight line, to address co-operatively the sub-set of sub-volumes that defines the at least part of the surface.

19. A controller as claimed in claim 18, wherein the circuitry is additionally configured to convert a distance along a first straight line at a first position to a second position of a second straight line that intersects the first straight line at the first position.

20. An apparatus comprising:
at least one processor; and
at least one memory including computer program code the at least one memory and the computer program code configured to, with the at least one processor, cause the apparatus at least to perform accessing a data structure that defines at least part of a surface within a volume, comprised of a non-overlapping set of sub-volumes, by specifying, for different first positions of a first straight line, a distance along the first straight line of a sub-volume of a sub-set of sub-volumes that defines the at least part of the surface; and
using the data structure to control a first scanner, configured to address sub-volumes that lie along a first straight line at different positions of the first straight line, and to control a second scanner, configured to address sub-volumes that lie along a second straight line for different positions of the second straight line, to address co-operatively the sub-set of sub-volumes that defines the at least part of the surface.

21. An apparatus as claimed in claim 20, wherein the at least one memory and the computer program code are configured to, with the at least one processor, cause the apparatus at least to perform additionally:
conversion of a distance along a first straight line at a first position to a second position of a second straight line that intersects the first straight line at the first position.

22. An application specific processor for use in the method of claim 1, configured to convert a distance along a first straight line at a first position to a second position of a second straight line that intersects the first straight line at the first position.

23. A volumetric imaging application specific processor configured to convert a series of distance values, for distances along a first straight line at a series of different first positions, to a series of second positions of a second straight line that serially intersects the first straight line at the series of different first positions.
